(19) United States
(12) Patent Application Publication
(10) Pub. No.: US 2026/0171326 A1
(43) Pub. Date: Jun. 18, 2026

(54) SOLID ELECTROLYTIC CAPACITOR AND METHOD FOR PRODUCING THE SAME

(71) Applicant: Panasonic Intellectual Property Management Co., Ltd., Kadoma-shi (JP)

(72) Inventors: Tomoyuki Taniguchi, Osaka Fu (JP); Kohei Goto, Osaka Fu (JP)

(73) Assignee: Panasonic Intellectual Property Management Co., Ltd., Kadoma-shi (JP)

(21) Appl. No.: 19/421,275

(22) Filed: Dec. 16, 2025

(30) Foreign Application Priority Data
Dec. 18, 2024 (JP) 2024-221581

(51) Int. Cl. H01G 9/028; H01G 9/00; H01G 9/04; H01G 9/052; H01G 9/15

(52) U.S. Cl. CPC H01G 9/028; H01G 9/0036; H01G 9/052; H01G 9/15; H01G 2009/05

(57) ABSTRACT

A capacitor element included in a solid electrolytic capacitor includes an anode body including a porous portion at least in a surface layer, a dielectric layer, and a solid electrolyte layer. The solid electrolyte layer has a first portion packed in voids of the porous portion in the anode body having the dielectric layer, and a second portion protruding from the principal surface of the anode body having the dielectric layer. The first portion contains an antioxidant component, and includes a solid electrolyte 2a, and a solid electrolyte 2b covering at least part of the solid electrolyte 2a. The solid electrolyte 2a includes a non-self-doping conductive polymer 2a. The solid electrolyte 2b includes a non-self-doping conductive polymer 2b. A conductivity C2a measured with respect to the solid electrolyte 2a and a conductivity C2b measured with respect to the solid electrolyte 2b satisfies C2a<C2b.

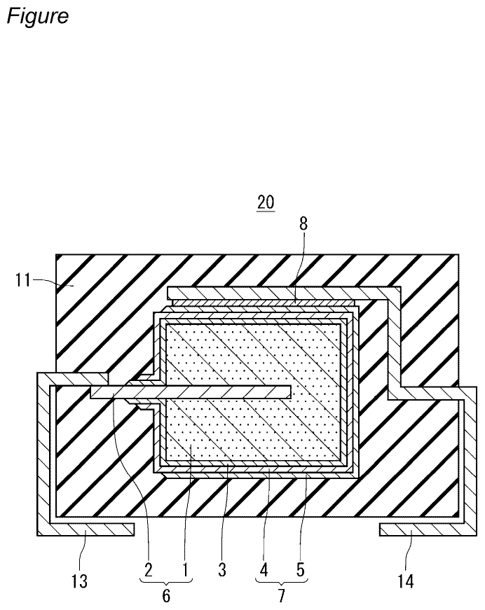

### CROSS REFERENCE TO RELATED APPLICATION

The present application is based on and claims priority under 35 U.S.C. § 119 with respect to the Japanese Patent Application No. 2024-221581 filed on Dec. 18, 2024, of which entire content is incorporated herein by reference into the present application.

### TECHNICAL FIELD

The present disclosure relates to a solid electrolytic capacitor and a method for producing the same.

### BACKGROUND

A solid electrolytic capacitor includes, for example, a capacitor element, and a package body sealing the capacitor element. The capacitor element includes, for example, a conductive body (specifically, an anode body), a dielectric layer formed on the surface of the conductive body, and a solid electrolyte layer covering at least part of the dielectric layer. The solid electrolyte layer is formed by, for example, chemical polymerization or electrolytic polymerization, and also can be formed using a processing solution, such as a liquid dispersion, containing a conductive polymer. The conductive polymer may be, for example, a self-doping conductive polymer or a non-self-doping conductive polymer, such as a conjugated polymer and a dopant.

Patent Literature 1 (JP2015-532525A) proposes a capacitor including an electrode body (1) of an electrode material (2), wherein: a dielectric (3) at least partially covers a surface (4) of the electrode material (2), forming an anode body (5); and the anode body (5) is at least partially coated with a solid electrolyte (6) which includes a foreign-doped conductive polymer, a counter-ion not to be covalently bonded to the foreign-doped conductive polymer, and a self-doping conductive polymer.

Patent Literature 2 (JP2023-13918A) proposes a solid electrolytic capacitor including an anode body formed from a valve metal, a dielectric layer formed on the anode body, and a solid electrolyte layer formed on the dielectric layer. The solid electrolyte layer includes: a first conductive polymer layer that is formed on the dielectric layer and is heterogeneously doped with a monomolecular dopant; a block layer that is formed on the first conductive polymer layer; and a second conductive polymer layer that is formed on the block layer and is formed from a self-doping conductive polymer having a plurality of side chains each having a dopable functional group. The block layer blocks a migration of the self-doping conductive polymer from the second conductive polymer layer to the first conductive polymer layer, and/or a migration of the self-doping conductive polymer from the second conductive polymer layer into pores of the porous anode body.

### SUMMARY

There is a demand for a solid electrolytic capacitor in which the decrease in capacitance is suppressed even after repeated charging and discharging, leading to high reliability, and in which the leakage current is suppressed.

A first aspect of the present disclosure relates to a solid electrolytic capacitor, including:
at least one capacitor element; and a package body, wherein
the capacitor element includes an anode body including a porous portion at least in a surface layer, a dielectric layer covering at least part of a surface of the anode body, and a solid electrolyte layer covering at least part of the dielectric layer,
the solid electrolyte layer has a first portion packed in voids of the porous portion in the anode body having the dielectric layer, and a second portion protruding from a principal surface of the anode body having the dielectric layer,
the first portion contains an antioxidant component, and includes a solid electrolyte 2a, and a solid electrolyte 2b covering at least part of the solid electrolyte 2a,
the solid electrolyte 2a includes a non-self-doping conductive polymer 2a,
the solid electrolyte 2b includes a non-self-doping conductive polymer 2b, and
a conductivity C2a measured with respect to the solid electrolyte 2a and a conductivity C2b measured with respect to the solid electrolyte 2b satisfies C2a<C2b.

A second aspect of the present disclosure relates to a method for producing a solid electrolytic capacitor including at least one capacitor element and a package body,
the capacitor element including: an anode body including a porous portion at least in a surface layer of the anode body; a dielectric layer covering at least part of a surface of the anode body; and a solid electrolyte layer covering at least part of the dielectric layer, wherein
the solid electrolyte layer has a first portion packed in voids of the porous portion in the anode body having the dielectric layer, and a second portion protruding from a principal surface of the anode body having the dielectric layer,
the method comprising a step of forming the solid electrolyte layer, wherein
the step of forming the solid electrolyte layer includes a step of forming the first portion, and a step of forming the second portion,
the step of forming the first portion includes a step of forming a solid electrolyte 2a using a processing solution 2a containing a non-self-doping conductive polymer 2a, and a step of forming a solid electrolyte 2b using a processing solution 2b containing a non-self-doping conductive polymer 2b so as to cover at least part of the solid electrolyte 2a,
at least one of the processing solution 2a and the processing solution 2b further contains an antioxidant component,
the processing solution 2a further contains a resistive component,
the processing solution 2b contains no resistive component or further contains a resistive component, and
a concentration of the resistive component in the processing solution 2a is higher than a concentration of the resistive component in the processing solution 2b.

According to the present disclosure, it is possible to ensure high reliability of the solid electrolytic capacitor, and reduce the leakage current.

### BRIEF DESCRIPTION OF THE DRAWING

FIGURE is a schematic sectional view of a solid electrolytic capacitor according to an embodiment of the present disclosure.

### DETAILED DESCRIPTION

While the novel features of the invention are set forth particularly in the appended claims, the invention, both as to organization and content, will be better understood and appreciated, along with other objects and features thereof, from the following detailed description taken in conjunction with the drawings.

Embodiments of the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. For the components other than those characteristic of the present disclosure, any known components for capacitors may be adopted. In the present specification, when referring to “a range of a numerical value A to a numerical value B,” the range includes the numerical value A and the numerical value B. When a plurality of materials are mentioned as examples, one kind of them may be selected and used singly, or two or more kinds of them may be used in combination.

The present disclosure encompasses a combination of matters recited in any two or more claims selected from plural claims in the appended claims. In other words, as long as no technical contradiction arises, matters recited in any two or more claims selected from plural claims in the appended claims can be combined.

A “solid electrolytic capacitor” is an “electrolytic capacitor” containing a solid electrolyte, and may be simply referred to as an “electrolytic capacitor”.

When a solid electrolytic capacitor is subjected to repeated charging and discharging or exposed to a high-temperature environment, the reliability of the solid electrolytic capacitor may be reduced in some cases. Specifically, the capacitance may decrease, or the ESR (equivalent series resistance) may increase. This is presumably resulted from the oxidative degradation of the solid electrolyte layer, the peeling in the solid electrolyte layer, and other causes. The peeling in the solid electrolyte layer includes an internal peeling within the solid electrolyte layer and an interlayer peeling between the dielectric layer and the solid electrolyte layer. Due to the oxidative degradation and the peeling, the conductive performance of the solid electrolyte layer and the conductive performance between the dielectric layer and the solid electrolyte layer are lowered.

The present inventors have found that, in a solid electrolytic capacitor, when the solid electrolyte layer contains an antioxidant, the oxidative degradation etc. of the conductive polymer are suppressed, so that the decrease in capacitance and the increase in ESR can be suppressed. However, it has been revealed that, in such a solid electrolytic capacitor, the leakage current may increase, failing to achieve a sufficient reliability.

### Technique (1)

A solid electrolytic capacitor according to the first aspect of the present disclosure includes at least one capacitor element and a package body. The capacitor element includes an anode body including a porous portion at least in a surface layer, a dielectric layer covering at least part of a surface of the anode body, and a solid electrolyte layer covering at least part of the dielectric layer. The solid electrolyte layer has a first portion packed in the voids of the porous portion in the anode body having the dielectric layer, and a second portion protruding from the principal surface of the anode body having the dielectric layer. The first portion contains an antioxidant component, and includes a solid electrolyte 2a having a conductivity C2a, and a solid electrolyte 2b covering at least part of the solid electrolyte 2a and having a conductivity C2b. The solid electrolyte 2a includes a non-self-doping conductive polymer 2a. The solid electrolyte 2b includes a non-self-doping conductive polymer 2b. The conductivity C2a measured with respect to the solid electrolyte 2a and the conductivity C2b measured with respect to the solid electrolyte 2b satisfies C2a<C2b.

In the present disclosure, the first portion contains a non-self-doping conductive polymer and an antioxidant component. Furthermore, as described above, the respective conductivities C2a and C2b of the solid electrolytes 2a and 2b constituting the first portion satisfy C2a<C2b. By this, the decrease in capacitance during repeated charging and discharging can be suppressed, and the leakage current can be reduced. Also, high withstand voltage performance of the solid electrolytic capacitor can be obtained.

Specifically, in the present disclosure, presumably because the first portion contains an antioxidant component, the oxidative degradation of the conductive polymer is suppressed, and the internal peeing and the interlayer peeling in the solid electrolyte layer are suppressed. This presumably suppresses the decrease in capacitance during repeated charging and discharging, leading to high reliability. On the other hand, when the first portion contains an antioxidant, the layer repair performance of the dielectric layer tends to degrade, and leakage current tends to increase. With increase of the leakage current, the product failure rate due to leakage current (also referred to as the leakage current failure rate) increases. In the present disclosure, the relationship between the respective conductivities of the solid electrolytes 2a and 2b satisfies C2a<C2b. By disposing the solid electrolyte 2a with low conductivity on the side closer to the dielectric layer, the leakage current can be reduced, and the withstand voltage performance can be enhanced. Furthermore, by including the solid electrolyte 2b with high conductivity, high capacitance can be maintained, likely leading to high reliability. Also, the equivalent series resistance (ESR) of the solid electrolytic capacitor can be suppressed low.

It is not yet clear the reason why the antioxidant can suppress not only the oxidative degradation of the conductive polymers but also the internal peeling in the solid electrolyte layer and the interlayer peeling. It is presumed that the antioxidant can improve the film quality of the solid electrolyte layer, which contributes to suppressing the internal peeling and the interlayer peeling. It has also been found that the antioxidant can improve the strength of the solid electrolyte layer, which improves the adhesion between the solid electrolyte layer and the dielectric layer. Such improved adhesion is considered to contribute to improving the reliability.

### Technique (2)

In the above technique (1), the first portion may include a first solid electrolyte covering at least part of the dielectric layer, and a second solid electrolyte covering at least part of the first solid electrolyte. The first solid electrolyte may include a self-doping conductive polymer. The second solid electrolyte may include the solid electrolyte 2a covering at least part of the first solid electrolyte, and the solid electrolyte 2b. Self-doping conductive polymers are small in particle size and easy to impregnate into the porous portion, and thus are suitable for coating the surface of the dielectric layer. By covering at least part of the dielectric layer with a first solid electrolyte containing a self-doping conductive polymer, a second solid electrolyte containing a non-self-doping conductive polymer and an antioxidant component can be easily formed. This allows the effect by the second solid electrolyte to be more easily exerted. As a result, higher reliability can be achieved, and the leakage current can be further reduced.

### Technique (3)

In the above techniques (1) or (2), the conductivity C2b measured with respect to a thin film having a thickness of 5 μm of the solid electrolyte 2b is preferably 200 S/cm or more. In this case, by including the solid electrolyte 2b, higher capacitance can be maintained, likely leading to high reliability. Also, the equivalent series resistance (ESR) of the solid electrolytic capacitor can be suppressed low.

### Technique (4)

In any one of the above techniques (1) to (3), the conductivity C2a measured with respect to a thin film having a thickness of 5 μm of the solid electrolyte 2a is preferably 1 S/cm or less. By disposing the solid electrolyte 2a with low conductivity on the side closer to the dielectric layer in the first portion, the leakage current can be further reduced, and higher withstand voltage performance can be obtained.

### Technique (5)

In any one of the above techniques (1) to (4), a ratio T2b/T2a of an average thickness T2b of the solid electrolyte 2b to an average thickness T2a of the solid electrolyte 2a is preferably 2 or more and 5 or less. This makes it easy to obtain higher capacitance and higher reliability, while suppressing the leakage current low.

### Technique (6)

In any one of the above techniques (1) to (5), the second portion may contain no antioxidant component or may contain an antioxidant component. A content ratio by mass of the antioxidant component in the first portion is preferably higher than a content ratio by mass of the antioxidant component in the second portion. The first portion which is disposed closer to the dielectric layer has a greater influence on the reliability of the solid electrolytic capacitor than the second portion which is disposed farther from the dielectric layer. By containing an antioxidant in a sufficiently high content ratio in the first portion, the reliability of the solid electrolytic capacitor can be efficiently enhanced.

### Technique (7)

In any one of the above techniques (1) to (6), the second portion preferably does not contain the antioxidant component. In the technique (6) or (7), the antioxidant component serving as the insulator is not contained in the second portion. This can maintain the ESR of the solid electrolytic capacitor low, and improves the capacitance leading performance.

### Technique (8)

In any one of the above techniques (1) to (7), the first portion preferably contains silicon element. In the first portion, the solid electrolytes 2a and 2b differ in electrical conductivity. The conductivity can be adjusted by, for example, adjusting the content ratio of a resistive component, such as a silane compound, in the solid electrolyte. Therefore, when the first portion contains silicon element, as compared when containing no silicon element, the conductivity is lowered, and the leakage current can be easily reduced.

### Technique (9)

In the above technique (8), a silicon element content by mass in the solid electrolyte 2a is preferably higher than a silicon element content by mass in the solid electrolyte 2b. In this case, the conductivity of each of the solid electrolytes 2a and 2b can be easily adjusted by a silane compound or the like, so that the relationship C2a<C2b can be satisfied. As a result, high reliability and suppressed leakage current can be both easily achieved. Also, by analyzing the silicon element, the relationship C2a<C2b can be easily confirmed.

### Technique (10)

The present disclosure also encompasses a method for producing a solid electrolytic capacitor including at least one capacitor element and a package body. The capacitor element includes an anode body including a porous portion at least in a surface layer of the anode body, a dielectric layer covering at least part of a surface of the anode body, and a solid electrolyte layer covering at least part of the dielectric layer. The solid electrolyte layer has a first portion packed in the voids of the porous portion in the anode body having the dielectric layer, and a second portion protruding from a principal surface of the anode body having the dielectric layer. The production method includes a step of forming the solid electrolyte layer. The step of forming the solid electrolyte layer includes a step of forming the first portion, and a step of forming the second portion. The step of forming the first portion includes a step of forming a solid electrolyte 2a using a processing solution 2a containing a non-self-doping conductive polymer 2a, and a step of forming a solid electrolyte 2b using a processing solution 2b containing a non-self-doping conductive polymer 2b so as to cover at least part of the solid electrolyte 2a. At least one of the processing solution 2a and the processing solution 2b further contains an antioxidant component. The processing solution 2a further contains a resistive component. The processing solution 2b contains no resistive component or further contains a resistive component. A concentration of the resistive component in the processing solution 2a is higher than a concentration of the resistive component in the processing solution 2b.

According to such a production method, the solid electrolytes 2a and 2b having conductivities satisfying the relationship C2a<C2b are formed. With the first portion containing the solid electrolytes 2a and 2b, the leakage current can be suppressed. Furthermore, with the first portion containing the antioxidant component, high reliability can be obtained.

### Technique (11)

In the above technique (10), the resistive component may include a silane compound. By using a silane compound as the resistive component, while ensuring high capacitor performance, the conductivities of the solid electrolytes 2a and 2b can be easily adjusted.

### Technique (12)

In the above technique (10) or (11), the first portion may include a first solid electrolyte covering at least part of the dielectric layer, and a second solid electrolyte covering at least part of the first solid electrolyte. The second solid electrolyte includes the solid electrolyte 2a covering at least part of the first solid electrolyte, and the solid electrolyte 2b. The step of forming the first portion includes a step of forming the first solid electrolyte using a first processing solution containing a self-doping conductive polymer. The step of forming the solid electrolyte 2a is performed so as to cover at least part of the first solid electrolyte. Since the first solid electrolyte containing a self-doping conductive polymer is formed prior to forming the second solid electrolyte, the inner surfaces of the porous portion are easily coated with the first solid electrolyte, and a second solid electrolyte that contains a non-self-doping conductive polymer and an antioxidant component can be easily formed. This allows the effect by the second solid electrolyte to be more easily exerted. As a result, higher reliability can be obtained, and the leakage current can be further reduced.

In the following, a solid electrolytic capacitor and a production method therefor according to the present disclosure will be specifically described below, including the above-described techniques (1) to (12), with reference to the drawing as needed. At least one of the above-described techniques (1) to (12) may be combined with at least one of the elements described below, as long as no technical contradiction arises. Note that the FIGURE is a schematic illustration, and the ratio etc. of the dimensions (e.g., thickness) of each component may differ from the actual ones.

### [Solid Electrolytic Capacitor]

The solid electrolytic capacitor of the present disclosure includes a capacitor element. The solid electrolytic capacitor has at least one capacitor element. The solid electrolytic capacitor may have two or more capacitor elements.

### (Capacitor Element)

The capacitor element includes an anode body, a dielectric layer covering at least part of the surface of the anode body, and a cathode part covering at least part of the dielectric layer. The cathode part includes a solid electrolyte layer covering at least part of the dielectric layer. The cathode part may include a cathode leading layer covering at least part of the solid electrolyte layer.

### (Anode Body)

The anode body includes, for example, a valve metal, an alloy containing a valve metal, or a compound containing a valve metal. The anode body may include these materials singly or in combination of two or more kinds. As the valve metal, for example, aluminum, tantalum, niobium, and titanium are preferred.

The anode body includes a porous portion in at least the surface layer. This increases the surface area of the anode body, making it possible to ensure higher capacitance.

The anode body having a porous portion in the surface layer can be obtained by, for example, roughening the surface of a substrate (a substrate in the form of sheet (e.g., the form of foil or plate), etc.) containing a valve metal, by etching or other techniques. Surface roughening can be performed by, for example, etching processing.

An anode foil having a porous surface layer includes, for example, a core portion and a porous portion integrated with the core portion. The porous portion may be formed in each of the surface layers of the two principal surfaces of the anode foil.

The thickness of the anode foil is, for example, 15 μm or more and 300 μm or less.

The anode body may be a porous molded body of particles containing a valve metal, or a porous sintered body thereof. In the porous molded body and the porous sintered body, usually, the whole anode body has a porous structure. Each of the molded body and the sintered body may be in the form of sheet, and may be in the shape of a rectangular parallelepiped or a cube, or a shape similar thereto.

The anode body includes, for example, a cathode-forming portion where a cathode part (esp. a solid electrolyte layer) is to be formed via a dielectric layer, and an anode portion where no cathode part is to be formed. A separation part for ensuring the electrical insulation between the cathode part and the anode portion may be formed at an end facing the cathode-forming portion of the anode portion. Of the anode portion, a portion without the separation part is sometimes called an anode leading portion. An anode lead terminal may be connected to the anode portion. The separation part may be formed from, for example, an electrically insulating material, such as an insulating resin.

When the anode body is a porous molded body or a sintered body, a metal lead member is partially embedded in the molded body or the sintered body.

### (Dielectric Layer)

The dielectric layer is an electrically insulating layer that functions as a dielectric. The dielectric layer may be an oxide layer. The surface of the dielectric layer has fine irregularities corresponding to the shape of the surface the porous portion of the anode body.

The dielectric layer, which is an oxide layer, may be formed on the surface of the anode body by, for example, subjecting the anode body to a chemical conversion. The chemical conversion may be performed by, for example, immersing the anode body in a chemical conversion solution and anodizing the surface of the anode body. The chemical conversion solution may be, for example, a solution containing an acid, such as phosphoric acid and adipic acid. The oxide layer may be formed using a vapor phase method, or by heating the anode body in an oxygen-containing atmosphere, to oxidize the surface.

The dielectric layer may contain an oxide of a valve metal. For example, when the valve metal is tantalum, the dielectric layer contains Ta₂O₅. When the valve metal aluminum, the dielectric layer contains Al₂O₃. However, the dielectric layer is not limited to these specific examples.

### (Solid Electrolyte Layer)

The solid electrolyte layer has a first portion and a second portion. The first portion is, in the anode body at least part of which has the dielectric layer, a portion packed in the voids of the porous portion. On the other hand, the second portion is a portion protruding from the principal surface of the anode body having the dielectric layer.

Part of the first portion may protrude from the principal surface of the porous portion having the dielectric layer, without packed in the voids of the porous portion having the dielectric layer. That is, the first portion may have an inner layer packed in the voids of the porous portion having the dielectric layer, and an outer layer protruding from the principal surface of the porous portion having the dielectric layer.

The second portion may be formed like a skin covering the anode body having the dielectric layer. Part of the second portion can be packed in the voids of the porous portion having the dielectric layer. However, a ratio by volume (Rv1) of the inner layer of the first portion to the whole first portion is higher than a ratio by volume (Rv2) of the part of the second portion that can be packed in the voids of the porous portion having the dielectric layer to the whole second portion. The Rv1 is at least twice or more the Rv2.

### (First Portion)

In the present disclosure, the first portion of the solid electrolyte layer contains an antioxidant component.

### (Antioxidant Component)

The antioxidant component is a component that has a function to inactivate the radicals generated due to the involvement of oxygen. The antioxidant component encompasses not only a component generally known as an antioxidant, but also a component known as an antidegradant, an antiaging agent, a radical chain inhibitor, a peroxide decomposer, a chain initiation inhibitor, a light stabilizer, a heat stabilizer (or heat resistant stabilizer), a metal deactivator, a UV absorber, and a weathering stabilizer.

The antioxidant component may be, for example, an antioxidant containing at least one selected from the group consisting of a hydroxyl group, a nitrogen atom, an oxygen atom, a sulfur atom, and a phosphorus atom. Examples of such an antioxidant include a phenolic antioxidant, an amine-based antioxidant, a phosphorus-based antioxidant, a sulfur-based antioxidant, a benzimidazole-based antioxidant, and a carotenoid compound. Among them, a phenolic antioxidant is preferred in terms of its high effectiveness.

The phenolic antioxidant has a phenolic hydroxy group. The phenolic antioxidant, for example, may be a monocyclic compound containing only one aromatic ring having a phenolic hydroxy group, and may be a compound containing a plurality of aromatic rings having a phenolic hydroxy group. In particular, a monocyclic compound containing only one aromatic ring having a phenolic hydroxy group is preferred in terms of its small molecular weight and high effectiveness even with a small amount. From the viewpoint of maintaining the conductivity of the solid electrolyte layer high, a material with low insulating properties is preferred. Such a phenolic antioxidant may contain two or more phenolic hydroxy groups in one molecule, and may contain three or more phenolic hydroxy groups in one molecule. The upper limit of the number of phenolic hydroxy groups bonded to the aromatic ring can be selected depending on the size of the aromatic ring, and may be, for example, five or less, four or less, or three or less. Examples of such a phenolic antioxidant include pyrogallol, catechol, gallic acid, and L-ascorbic acid. These are preferred also in terms of having water solubility. The antioxidant component preferably contains a water-soluble antioxidant. This is because the antioxidant can be easily uniform dispersed in an aqueous processing solution containing a non-self-doping conductive polymer.

The aromatic ring having a phenolic hydroxy group may be a condensed ring in which an aromatic ring and a non-aromatic ring are condensed. Each of the aromatic ring and the non-aromatic ring may be either a hydrocarbon ring or a hetero ring. The non-aromatic ring may be a bridged ring. Examples of the aromatic ring include: an aromatic hydrocarbon ring having 6 to 20 carbon atoms (e.g., 6 to 14, or 6 to 10 carbon atoms), such as benzene, naphthalene, phenanthrene, and anthracene; and a 5- to 20-membered (e.g., 6- to 14-membered) hetero ring, such as furan, pyrrole, thiophene, imidazole, pyridine, pyrazine, quinoline, indole, benzimidazole, benzotriazole, and purine. Examples of the condensed ring in which an aromatic ring and a non-aromatic ring are condensed include chromene, chromone, chroman, coumarin, 4H-chromen-4-one, and carbazole. Examples of the non-aromatic ring include: an alicyclic hydrocarbon ring having 5 to 14 carbon atoms (e.g., 5 to 10 carbon atoms), such as cyclopentane, cyclohexane, and cyclooctane; a bridged cyclic hydrocarbon ring having 6 to 20 carbon atoms (e.g., 6 to 14 carbon atoms), such as norbornane, norbornene, and dicyclopentadiene; and a 5- to 20-membered (e.g., 6- to 14-membered) non-aromatic hetero ring, such as tetrahydrofuran, dioxolane, dioxane, pyrrolidine, piperidine, morpholine, and thiazine.

The antioxidant component may contain these antioxidants singly or in combination of two or more kinds.

The first portion includes at least a solid electrolyte 2a, and a solid electrolyte 2b covering at least part of the solid electrolyte 2a. The solid electrolyte 2a may cover at least part of the dielectric layer. The first portion may further include a first solid electrolyte covering at least part of the dielectric layer. In this case, the first portion includes a second solid electrolyte covering at least part of the first solid electrolyte. The second solid electrolyte includes the solid electrolyte 2a covering at least part of the first solid electrolyte, and the solid electrolyte 2b.

The antioxidant component may be contained in whichever the first solid electrolyte or the second solid electrolyte. From the viewpoint of achieving higher reliability, it is preferable that the antioxidant component is contained in at least the second solid electrolyte. The antioxidant component may be contained in both the solid electrolyte 2a and the solid electrolyte 2b, or in either one of them. The first solid electrolyte may contain no antioxidant component.

The content ratio by mass of the antioxidant component in the first portion may be 0.1 mass % or more and 40 mass % or less, may be 1 mass % or more and 35 mass % or less, and may be 10 mass % or more and 30 mass % or less. When the antioxidant component is contained in such content ratio by mass within the above range, higher capacitance can be ensured when the solid electrolytic capacitor is repeatedly charged and discharged, and higher reliability can be obtained.

In the solid electrolytic capacitor, the distribution of the antioxidant component in the solid electrolyte layer can be determined by a time-of-flight secondary ion mass spectrometry (TOF-SIMS) analysis. In the analysis, whichever the negative mode or the positive mode may be adopted, depending on the chemical species to be a target for analysis. The TOF-SIMS analysis is performed while etching the solid electrolyte layer from its outermost surface in the depth direction (e.g., from the outermost surface of the solid electrolyte layer toward the anode body).

### (First Solid Electrolyte)

The first solid electrolyte includes, for example, a self-doping conductive polymer.

The self-doping conductive polymer has, for example, a backbone of a conjugated polymer and a functional group, such as an anionic group, that functions as a dopant bonded directly or indirectly to the backbone via a covalently bond.

Examples of the anionic group include a sulfo group, a carboxy group, a phosphate group, and a phosphonate group. The self-doping conductive polymer may contain these anionic groups singly or in combination of two or more kinds. From the viewpoint of ensuring higher conductivity of the self-doping conductive polymer, the self-doping conductive polymer may contain at least a sulfo group.

The anionic group of the self-doping conductive polymer may be present in any form, such as anion, acid, ester, and salt, and may be present in a form that has been interacted with or formed into a composite with a component contained in the solid electrolyte layer. In the present specification, all of these forms are simply referred to as an anionic group.

The conjugated polymer constituting the backbone of the self-doping conductive polymer may be, for example, a polymer whose backbone is a n-conjugated polymer, such as polypyrrole, polythiophene, polyaniline, polyfuran, polyacetylene, polyphenylene, polyphenylene vinylene, polyacene, and polythiophene vinylene. The above polymer contains at least one kind of monomer that constitutes the backbone. The above polymer also include a homopolymer, a copolymer of two or more kinds of monomers, and a derivative thereof (e.g., a substituted derivative thereof having a substituent). For example, polythiophene includes poly(3,4-ethylenedioxythiophene), and the like. The self-doping conductive polymer has an anionic group on the backbone of these conjugated polymers. The anionic group may be introduced directly on the backbone of the conjugated polymer, and may be introduced via a linking group. The linking group is preferably a polyvalent group (divalent group) including an alkylene group. Examples of the linking group include: an aliphatic polyvalent group (divalent group, etc.), such as an alkylene group; and a —R¹—X—R²— group, where X is oxygen or sulfur, and R¹ and R² are the same or different, and an alkylene group. The number of carbon atoms in each of the alkylene group contained in the linking group is, for example, 1 to 10, and may be 1 to 6. The alkylene group may be linear or branched. The linking group may contain, for example, at least an alkylene group having 2 or more carbon atoms. The number of carbon atoms in such an alkylene group may be 2 (or 3) to 10, and may be 2 (or 3) to 6. For example, R¹ may be an alkylene group having 1 to 6 carbon atoms, and R² may be an alkylene group having 2 (or 3) to 10 carbon atoms. The linking group, however, is not limited thereto.

The conjugated polymer constituting the backbone of the self-doping conductive polymer may be polypyrrole, polythiophene, or polyaniline. From the viewpoint of achieving high conductivity, a preferred self-doping conductive polymer is a polymer having a backbone of a conjugated polymer including a repeating structure of a monomer unit corresponding to a thiophene compound, and an anionic group introduced on the backbone.

As the thiophene compound, a compound that has a thiophene ring and is capable of forming a repeating structure of a monomer unit corresponding thereto can be used. The thiophene compound can form a repeating structure of a monomer unit in which the thiophene rings are linked at the 2- and 5-positions.

The thiophene compound may have a substituent at least at one of the 3- and 4-positions of the thiophene ring. The substituent at the 3-position and the substituent at the 4-position may be linked to each other, forming a ring condensed to the thiophene ring. Examples of the thiophene compound include: a thiophene that may have a substituent at least at one of the 3- and 4-positions; and an alkylenedioxythiophene compound (e.g., a C₂₋₄ alkylenedioxythiophene compound, such as ethylenedioxythiophene compound). The alkylenedioxythiophene compound also includes a compound having a substituent in the place of the alkylene group.

As the substituent, an alkyl group (e.g., a C₁₋₄ alkyl group, such as methyl and ethyl), an alkoxy group (e.g., a C₁₋₄ alkoxy group, such as methoxy and ethoxy), a hydroxy group, a hydroxyalkyl group (e.g., a hydroxy C₁₋₄ alkyl group, such as hydroxymethyl), and the like are preferred, but not limited thereto. When the thiophene compound has two or more substituents, the respective substituents may be the same or different. The thiophene ring (in the alkylenedioxythiophene ring, at least one of the thiophene ring and the alkylene group) may have, as a substituent, the aforementioned anionic group or a group containing the anionic group (e.g., a sulfoalkyl group, etc.).

The self-doping conductive polymer may have a backbone of a conjugated polymer, such as PEDOT, including a repeating structure of a monomer unit corresponding to at least a 3,4-ethylenedioxythiophene compound, such as 3,4-ethylenedioxythiophene (EDOT). The backbone of a conjugated polymer including a repeating structure of a monomer unit corresponding to at least EDOT may contain only a monomer unit corresponding to EDOT, and may contain, in addition to the above monomer unit, a monomer unit corresponding to a thiophene compound other than EDOT.

An example of the monomer unit in the self-doping conductive polymer is shown below. The symbol * indicates a binding site.

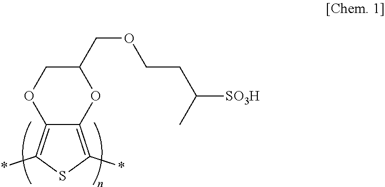

The weight-average molecular weight (Mw) of the self-doping conductive polymer may be 1,000 or more and 1,000,000 or less, and may be 1,000 or more and 50,000 or less.

In the present specification, the weight-average molecular weight (Mw) is a value in terms of polystyrene as measured by gel permeation chromatography (GPC). In the GPC, usually, a polystyrene gel column, and water/methanol (volume ratio 8/2) as a mobile phase are used for measurement.

### (Second Solid Electrolyte)

The second solid electrolyte includes the solid electrolyte 2a covering at least part of the dielectric layer or the first solid electrolyte, and the solid electrolyte 2b covering at least part of the solid electrolyte 2a. The second solid electrolyte preferably contains a non-self-doping conductive polymer, and preferably, further contains an antioxidant component. When the second solid electrolyte includes a non-self-doping conductive polymer, excellent conductive performance can be easily obtained. When the second solid electrolyte includes a non-self-doping conductive polymer and an antioxidant component, even after repeated charging and discharging, the oxidative degradation of the conductive polymer is suppressed, and also, the internal peeling and the interlayer peeling in the solid electrolyte layer are suppressed. Thus, excellent conductive performance can be maintained, and high capacitance can be achieved.

### (Non-Self-Doping Conductive Polymer)

The non-self-doping conductive polymer includes, for example, a non-self-doping conjugated polymer (e.g., a conjugated polymer having no anionic group) and a dopant.

The solid electrolyte 2a includes a non-self-doping conductive polymer 2a. The solid electrolyte 2b includes a non-self-doping conductive polymer 2b. The non-self-doping conductive polymer 2a and the non-self-doping conductive polymer 2b may be the same in terms of the kind and the molecular weight of the conjugated polymer and the dopant, and may be different in term of the kind and the molecular weight of at least one of the conjugated polymer and the dopant.

The conjugated polymer included in the non-self-doping conductive polymer may be a conjugated polymer, such as a π-conjugated polymer, as exemplified for the conjugated polymer constituting the backbone of the self-doping conductive polymer. The conjugated polymer may be used singly or in combination of two or more kinds. From the viewpoint of ensuring initial high capacitance and withstand voltage performance, and other properties such as high heat resistance, a non-self-doping conjugated polymer including a repeating structure of a monomer unit of a thiophene compound may also be used. The thiophene compound corresponding to the monomer unit of the non-self-doping conjugated polymer may be a thiophene compound as exemplified for the self-doping conductive polymer. The non-self-doping conjugated polymer may include a conjugated polymer (PEDOT, etc.) including a repeating structure of a monomer unit corresponding to at least 3,4-ethylenedioxythiophene compound (EDOT, etc.). The conjugated polymer including a repeating structure unit of a monomer unit corresponding to at least EDOT may contain only a monomer unit corresponding to EDOT, or may contain, in addition to the above monomer unit, a monomer unit corresponding to a thiophene compound other than EDOT.

The dopant may be at least one selected from the group consisting of anions and polyanions (e.g., polymer anions). Examples of the anions include sulfate ions, nitrate ions, phosphate ions, borate ions, organic sulfonate ions, and carboxylate ions. As the dopant that generates sulfonate ions, for example, p-toluenesulfonic acid, naphthalenesulfonic acid, and the like are exemplified. From the viewpoint of obtaining higher heat resistance and reliability, and ensuring hither withstand voltage performance, polymer anions may be used. As the polymer anions having a sulfo group, a polymer-type polysulfonic acid is exemplified. Specific examples of the polymer anions include polyvinyl sulfonic acid, polystyrene sulfonic acid (PSS (including its copolymer and its substituted derivative having a substituent), polyallylsulfonic acid, polyacrylic sulfonic acid, polymethacrylic sulfonic acid, poly(2-acrylamido-2-methylpropanesulfonic acid), polyisoprene sulfonic acid, polyester sulfonic acid (aromatic polyester sulfonic acid, etc.), and phenolsulfonic acid novolac resin. The dopant, however, is not limited to these specific examples. The dopant may be used singly or in combination of two or more kinds.

The non-self-doping conductive polymer (or each of the non-self-doping conductive polymers 2a and 2b) contained in the second solid electrolyte preferably contains a conjugated polymer (non-self-doping conjugated polymer) and a polymer anion. This is because excellent conductive performance of the solid electrolyte layer can be easily obtained, and in addition, the oxidative degradation of the conductive polymer can be suppressed, leading to higher reliability of the solid electrolytic capacitor.

In the non-self-doping conductive polymer, the amount of the dopant, relative to 100 parts by mass of the conjugated polymer, may be 10 parts by mass or more and 1000 parts by mass or less, and may be 20 parts by mass or more and 500 parts by mass or less.

### (Conductivity)

A conductivity C2a of the solid electrolyte 2a and a conductivity C2b of the solid electrolyte 2b satisfy C2a<C2b. When the first portion contains an antioxidant component, the layer repair performance of the dielectric layer is reduced, causing the leakage current to increase. In the present disclosure, the solid electrolyte 2a having low conductivity is present closer to the dielectric layer. This can significantly reduce the leakage current when the first portion contains an antioxidant component.

A ratio C2a/C2b of the conductivity C2a to the conductivity C2b is preferably 5 or more, more preferably 10 or more, or 100 or more, even more preferably 150 or more, or 200 or more. When the ratio between these electrical conductivities is within such a range, with the solid electrolyte 2a having low conductivity, the leakage current can be further reduced, and high withstand voltage performance can be ensured. Furthermore, with the solid electrolyte 2b having high conductivity, even higher capacitance can be easily obtained.

The conductivity C2a is preferably 5 S/cm or less, more preferably 1 S/cm or less. When the conductivity C2a is within such a range, the leakage current can be further reduced, and high withstand voltage performance can be obtained. The conductivity C2a may be 0.01 S/cm or more.

The conductivity C2b is preferably 100 S/cm or more, more preferably 200 S/cm or more. When the conductivity C2b is within such a range, higher capacitance can be easily obtained. The conductivity C2b may be 1000 S/cm or less.

The conductivity of each solid electrolyte may be, for example, a value obtained by preparing a sample of a thin film having the same composition as the solid electrolyte, and measuring the sample. A specific example of a measuring method of the conductivity will be described below. First, a processing solution for forming a solid electrolyte is applied onto the surface of a glass plate, followed by heating at a temperature of 140 to 180° C. for 10 to 20 minutes, to form a thin film (thickness 5 μm) of the solid electrolyte. The conductivity (S/cm) of the thin film is measured using Loresta-GP (MCP-T610 type, DC four-point probe) manufactured by Nitto Seiko Analytech Co., Ltd., which is determined as the conductivity of the solid electrolyte. A processing solution containing a conductive polymer for forming the solid electrolyte 2a or 2b is used to measure the conductivities C2a and C2b of thin films each having a thickness of 5 μm of the respective solid electrolytes.

### (Resistance Component)

The solid electrolyte 2a and the solid electrolyte 2b differ from each other in term of the conductivity as described above. The conductivity of each solid electrolyte may be adjusted by the composition of the solid electrolyte, which, however, can be easily adjusted by using a resistance component. Examples of the resistance component include an organic compound and a silane compound. From the viewpoint of dispersing more uniformly in the solid electrolyte, a resistance component with relatively low molecular weight is preferred. The molecular weight (or weight-average molecular weight) of the resistance component is preferably 3000 or less, and may be 2000 or less.

The silane compound is commercially available as a silane coupling agent, and is easily available. Adding a silane compound to the solid electrolyte can increase the resistance of the solid electrolyte, and reduce the peeling in the solid electrolyte layer.

As the silane compound, a compound having a silicon atom and four radicals covalently bonded to the silicon atom may be used. At least one of the four radicals may be a reactive functional group. The reactive functional group may be an epoxy group, a halogenated alkyl group, an amino group, a ureido group, a mercapto group, an isocyanate group, a polymerizable group, and the like. Examples of the polymerizable group include an acryloyl group, a methacryloyl group, and a vinyl group. At least one of the four radicals may be hydrolyzable. Examples of the hydrolyzable radical include: an alkoxy group, such as methoxy, ethoxy, and propoxy; and a halogen atom, such as chlorine and bromine.

The reactive functional group or hydrolyzable group of the silane compound may be interacted or bonded with other components (conductive polymer, etc.) contained in the solid electrolyte, the dielectric layer, and the like.

As the silane compound, a silane coupling agent may be used. As the silane coupling agent, a silane coupling agent having an epoxy group, a silane coupling agent having an acrylic group, and the like are preferred.

Examples of the silane coupling agent having an epoxy group include 2-(3,4-epoxycyclohexyl)ethyltrimethoxysilane, 3-glycidoxypropyltrimethoxysilane, 3-glycidoxypropylmethyldiethoxysilane, and 3-glycidoxypropyltriethoxysilane.

Examples of the silane coupling agent having an acrylic group include 3-methacryloxypropyl methyldimethoxysilane, 3-methacryloxypropyl trimethoxysilane, 3-methacryloxypropyl methyldiethoxysilane, 3-methacryloxypropyl triethoxysilane, and 3-acryloxypropyl trimethoxysilane (γ-acryloxypropyltrimethoxysilane).

Examples of other silane coupling agents include vinyltrichlorosilane, vinyltrimethoxysilane, vinyltriethoxysilane, p-styryltrimethoxysilane, N-2-(aminoethyl)-3-aminopropylmethyldimethoxysilane, N-2-(aminoethyl)-3-aminopropyltriethoxysilane, N-2-(aminoethyl)-3-aminopropyltrimethoxysilane, 3-aminopropyltrimethoxysilane, 3-aminopropyltriethoxysilane, 3-triethoxysilyl-N-1,3-dimethyl-butylidene)propylamine, N-phenyl-3-aminopropyltrimethoxysilane, a hydrochloride of N-(vinylbenzyl)-2-aminoethyl-3-aminopropyltrimethoxysilane, 3-ureidopropyltriethoxysilane, 3-chloropropyltrimethoxysilane, 3-mercaptopropylmethyldimethoxysilane, 3-mercaptopropyltrimethoxysilane, bis(triethoxysilylpropyl)tetrasulfide, and 3-isocyanatopropyltriethoxysilane.

These resistive components (e.g., silane compounds) may be used singly or in combination of two or more kinds.

### (Silicon Element)

The first portion may contain silicon element. When a silane compound is used to adjust the conductivity of the solid electrolyte, the solid electrolyte will contain silicon element derived from the silane compound. An elemental mapping of silicon may be used to confirm the presence of the silane compound, and to identify the relationship between the conductivities of the solid electrolytes.

In the present disclosure, the conductivities of the solid electrolyte 2a and the solid electrolyte 2b satisfy a relationship C2a<C2b. It can be said therefore that the silicon element content by mass in the solid electrolyte 2a is higher than that in the solid electrolyte 2b.

The silicon element content by mass in the solid electrolyte 2a is preferably 1 mass % or more and 500 mass % or less, more preferably 1 mass % or more and 100 mass % or less.

A ratio P2b/P2a of a silicon element content P2b by mass in the solid electrolyte 2b to a silicon element content P2a by mass in the solid electrolyte 2a is less than 1, which is preferably 0.10 or less, more preferably 0.01 or less. It is also preferable that the P2b is 0 mass %, i.e., the ratio P2b/P2a is 0.

The silicon elements in the solid electrolytes 2a and 2b can be determined by the following procedure. First, a sectional image (sectional image including the porous portion) in the thickness direction of the anode body of a solid electrolytic capacitor or a capacitor element is taken using a scanning electron microscope (SEM) or a transmission electron microscope (TEM). Next, the obtained image is used to perform elemental mapping by energy-dispersive X-ray spectroscopy (EDX) analysis, to obtain a map of the silicon element in a portion packed in the recesses of the porous portion. Using the above image, the solid electrolytes 2a and 2b can be distinguished from each other, based on the difference in the distribution of the silicon content. For example, the above two solid electrolytes can be distinguished by binarizing the image. In the elemental mapping, in the region of the metal oxide, a region where the second metal is distributed, which is determined as a second dielectric layer. In the metal oxide region, between the anode body and the second dielectric layer, a region where the first metal element is distributed, and the second metal element is not distributed (below the detection limit of the second metal) is identified, which is determined as a first dielectric layer. From the above elemental mapping, a presence percentage (content ratio by mass) of the silicon element contained in the solid electrolyte 2a and a presence percentage (content ratio by mass) of the silicon element contained in the solid electrolyte 2b are determined.

### (Thickness of Solid Electrolyte)

The average thickness of the solid electrolyte 2b is preferably larger than that of the solid electrolyte 2a. In this case, higher capacitance can be obtained. Also, the ESR can be suppressed low. Furthermore, even though the average thickness of the solid electrolyte 2a is relatively small, because of its low conductivity, the effect of reducing leakage current is ensured, leading to high withstand voltage performance.

A ratio T2b/T2a of an average thickness T2b of the solid electrolyte 2b to an average thickness T2a of the solid electrolyte 2a is preferably more than 1 and 10 or less, more preferably 2 or more and 7 or less, even more preferably 2 or more and 5 or less. When the ratio T2b/T2a is within such a range, high capacitance and high reliability can be easily obtained, while the leakage current is suppressed low.

The average thickness of each solid electrolyte is determined using the sectional image as used when determining the silicon content by mass. Specifically, first, in the above sectional image, the solid electrolyte 2a and the solid electrolyte 2b are distinguished from each other as described above. The average thickness is determined by measuring the thickness of each solid electrolyte at any 10 points in the sectional image, and calculating an average value of the measurements.

### (Second Portion)

The second portion may contain a self-doping conductive polymer, and may contain a non-self-doping conductive polymer. From the viewpoint of adjusting the thickness of the second portion and achieving excellent conductive performance, the second portion preferably contains a non-self-doping conductive polymer. For the self-doping conductive polymer and the non-self-doping conductive polymer, the description thereof in the first portion can be referred to.

The second portion may contain an antioxidant component, and may contain no antioxidant component. It is preferable, however, that the content ratio by mass of the antioxidant component in the first portion is higher than that in the second portion. When the content ratio by mass of the antioxidant component in the second portion is low, excellent conductive performance of the solid electrolyte layer can be easily obtained, so that initial high capacitance can be obtained, and the initial ESR can be suppressed low. The effect by the antioxidant component of suppressing the oxidative degradation of the conductive polymer can be more easily exerted in the first portion than in the second portion. In the present disclosure, the inclusion of the antioxidant component in the first portion results in high reliability of the solid electrolytic capacitor. It is also preferable that the second portion does not contain the antioxidant component. When the second portion does not contain the antioxidant component, this includes a case where the antioxidant component is below the detection limit in the second portion.

### (Others)

The solid electrolyte layer may contain an additive. Examples of the additive include known additives added to the solid electrolyte layer, and known conductive materials other than conductive polymers (e.g., conductive inorganic materials, such as manganese dioxide, TCNQ complex salts). The solid electrolyte layer may contain these additives singly or in combination of two or more kinds.

### (Formation of Solid Electrolyte Layer)

The method for producing a solid electrolytic capacitor according to the present disclosure includes a step of forming the solid electrolyte layer. The step of forming the solid electrolyte layer includes a step of forming a first portion, and a step of forming a second portion.

Each solid electrolyte is generally formed by using a processing solution (solution, liquid dispersion, etc.) containing the constituent components of the solid electrolyte, or by in-situ polymerization, such as chemical polymerization and electrolytic polymerization, using a polymerization solution containing a conjugated polymer precursor and a dopant. A method of utilizing in-situ polymerization and a method of using a liquid composition containing a conductive polymer may be used in combination. In in-situ polymerization, an oxidizing agent may be used, as necessary.

### (Step of Forming First Portion)

In the present disclosure, the step of forming the first portion includes a step of forming a solid electrolyte 2a using a processing solution 2a containing a non-self-doping conductive polymer 2a, and forming a solid electrolyte 2b using a processing solution 2b containing a non-self-doping conductive polymer 2b so as to cover at least part of the solid electrolyte 2a. The step of forming the first portion may include a step of forming a first solid electrolyte using a first processing solution containing a self-doping conductive polymer. In this case, a second solid electrolyte is formed so as to cover at least part of the first solid electrolyte. The step of forming the second solid electrolyte includes a step of forming the above solid electrolyte 2a so as to cover at least part of the first electrolyte, and a step of forming the solid electrolyte 2b.

### (Step of Forming First Solid Electrolyte)

A first solid electrolyte is formed by providing a first processing solution containing a self-doping conductive polymer onto an anode body having a dielectric layer. For example, the first processing solution may be applied to an anode body having a dielectric layer, or the anode body having a dielectric layer may be immersed in the first processing solution, so that the self-doping conductive polymer is attached so as to cover at least part of the dielectric layer. By forming the first solid electrolyte containing a self-doping conductive polymer prior to forming the second solid electrolyte, the inner surface of the porous structure is easily coated with the first solid electrolyte, so that a second solid electrolyte containing a non-self-doping conductive polymer and an antioxidant component can be easily formed. This allows the effect by the second solid electrolyte to be more easily exerted. Providing a first processing solution onto the anode body is usually followed by drying process. The providing of the first processing solution and the drying may be repeated.

The first processing solution contains, for example, a liquid medium. Examples of the liquid medium include water, an organic liquid medium, and a mixture thereof, depending on the kind of the self-doping conductive polymer. Using water is preferred, and using a mixture or the like of water and a water-soluble organic liquid medium is preferred. The organic liquid medium may be liquid at the stage of forming the first solid electrolyte, and may be, for example, an organic medium that is liquid at least in the temperature range of 25° C. to 35° C.

The first processing solution may be a dispersion in which particles of a self-doping conductive polymer are dispersed in a liquid medium, or a solution in which a self-doping conductive polymer is dissolved in a liquid medium. In the self-doping conductive polymer, the polymer chain is relatively flexible, and the position of the functional group, such as anionic group, is random. Moreover, in the self-doping conductive polymer, the orientation of the polymer chain is low, and the crystallinity is low. Therefore, as compared to the non-self-doping conductive polymer, the self-doping conductive polymer is easily dissolved in the liquid medium or dispersed in the form of fine particles. Therefore, the first processing solution has a relatively low viscosity, and can be easily impregnated into the voids in the porous portion with high permeability.

The concentration of the self-doping conductive polymer in the first processing solution may be 0.5 mass % or more and 5 mass % or less, may be 1 mass % or more and 3 mass % or less.

The first processing solution may contain an antioxidant component. The thickness of the first solid electrolyte tends to be small. Therefore, the antioxidant component is effective when contained in the second solid electrolyte. For this reason, when the first processing solution contains an antioxidant component, the concentration of the antioxidant component in the first processing solution is preferably lower than those in the processing solutions 2a and 2b as described below.

The concentration of the antioxidant component in the first processing solution may be 5 mass % or less, may be less than 3 mass %, may be 1 mass % or less, and may be 0.1 mass % or less. It is also preferable that the first processing solution contains no antioxidant component.

The first processing solution may contain a resistive component. However, from the viewpoint of forming the second solid electrolyte more uniformly, the first processing solution preferably contains no resistive component.

### (Step of Forming Second Solid Electrolyte)

The solid electrolyte 2a is formed by providing a processing solution 2a containing a non-self-doping conductive polymer 2a onto an anode body having a dielectric layer or an anode body with the first solid electrolyte formed therein (step of forming solid electrolyte 2a). The solid electrolyte 2b is formed by providing a processing solution 2b containing a non-self-doping conductive polymer 2b onto the anode body with the solid electrolyte 2a formed therein (step of forming solid electrolyte 2b). Providing the respective processing solutions may be followed by drying process. The providing of the processing solution and the drying may be repeated a plurality of times.

Each of the processing solutions 2a and 2b contains, for example, a liquid medium. Examples of the liquid medium include water, an organic liquid medium, and a mixture thereof, depending on the kind of the non-self-doping conductive polymer. Using water is preferred, and using a mixture or the like of water and a water-soluble organic liquid medium is preferred. The organic liquid medium may be liquid at the stage of forming the solid electrolyte 2a or 2b, and is an organic medium which is liquid, for example, at least in the temperature range of 25° C. to 35° C.

The concentration of the non-self-doping conductive polymer 2a in the processing solution 2a may be 0.5 mass % to 5 mass %, and may be 1 mass % to 3 mass %. The concentration of the non-self-doping conductive polymer 2b in the processing solution 2b may also be selected from a similar range.

In line with the description of the solid electrolyte 2a and the solid electrolyte 2b, at least one of the processing solutions 2a and 2b preferably contains an antioxidant component, and both of them may contain an antioxidant component. The antioxidant component contained in the processing solution 2a and the antioxidant component contained in the processing solution 2b may be the same or different. The concentration (mass %) of the antioxidant component in the processing solution 2a and that in the processing solution 2b may be the same or different.

The concentration of the antioxidant component in the processing solution 2a or 2b may be adjusted, as appropriate, depending on the concentration of the non-self-doping conductive polymer in each processing solution. The concentration of the antioxidant component in each processing solution may be 0.1 mass % or more and 10 mass % or less, and may be 1 mass % or more and 5 mass % or less. Each processing solution may contain an antioxidant component in an amount equal to or greater than the mass of the non-self-doping conductive polymer. It is estimated that part of the antioxidant component volatilizes during the drying process of the processing solution. As a result, the solid electrolyte 2a or a solid electrolyte 22 can be formed, which contains the antioxidant component at a content ratio by mass of, for example, 3 mass % or more and 40 mass % or less, or 10 mass % or more and 30 mass % or less. The content ratio by mass of the antioxidant component in each solid electrolyte is preferably higher than that in the first solid electrolyte.

In the present disclosure, the processing solution 2a further contains a resistive component. The processing solution 2b contains no resistive component or further contains a resistive component. The concentration of the resistive component in the processing solution 2a is higher than that in the processing solution 2b.

In the present disclosure, by setting the concentration (mass %) of the resistive component in the processing solution 2a higher than that in processing solution 2b, the conductivities of the solid electrolyte 2a and the solid electrolyte 2b can be adjusted to satisfy C2a<C2b. As already mentioned, the resistive component preferably contains a silane compound.

The concentration of the resistive component (or silane compound) in the processing solution 2a is preferably 0.01 mass % or more and 10 mass % or less, more preferably 0.1 mass % or more and 5 mass % or less. When the concentration of the resistive component in the processing solution 2a is within such a range, the conductivity of the solid electrolyte 2a can be suppressed relatively low, and the effect of the reducing leakage current can be easily obtained. In addition, high withstand voltage performance can be easily obtained.

The concentration of the resistive component (or silane compound) in the processing solution 2b is preferably 1 mass % or less, more preferably 0.01 mass % or less. When the processing solution 2b contains the resistive component (or silane compound), the concentration may be, for example, 0.001 mass %. The processing solution 2b may contain no resistive component (or silane compound), which is also preferable. In these cases, a relatively high conductivity can be obtained in the solid electrolyte 2b. This makes it easy to achieve initial high capacitance and low ESR.

In the step of forming the solid electrolyte 2a, it is preferable to use a processing solution 2a in the form of a solution or liquid dispersion, rather than utilizing in-situ polymerization. This is because the processing solution 2a in such a form is likely to stably contain an antioxidant component and a resistance component. Likewise, in the process of forming the solid electrolyte 2b, it is preferable to use a processing solution 2b in the form of a solution or liquid dispersion, rather than utilizing in-situ polymerization.

### (Step of Forming Second Portion)

The second portion, which may be formed using a polymerization solution containing a non-self-doping conjugated polymer precursor and a dopant, is preferably formed using a processing solution (second processing solution) containing a non-self-doping conductive polymer. Such a second processing solution is, for example, a solution or liquid dispersion containing a non-self-doping conductive polymer. The second processing solution contains, for example, a liquid medium.

The second processing solution is provided onto the anode body with the first portion formed therein, to form a second portion covering at least part of the first portion, so as to protrude from the principal surface of the anode body having the dielectric layer. The second processing solution may be dried after provided onto the first portion. The providing of the second processing solution onto the first portion and the drying may be repeated twice or more, as necessary.

In the second processing solution, the average particle diameter of the non-self-doping conductive polymer particles may be larger than the average particle diameter of the non-self-doping conductive polymer particles contained in the processing solution 2a or 2b.

Examples of the liquid medium contained in the second processing solution include water, an organic liquid medium, or a mixture thereof, depending on the kind of the non-self-doping conductive polymer. Using water is preferred, and using a mixture or the like of water and a water-soluble organic liquid medium is preferred. The organic liquid medium may be liquid at the stage of forming the second portion, and is an organic medium which is liquid, for example, at least in a temperature range of 25° C. to 35° C.

The concentration of the non-self-doping conductive polymer in the second processing solution may be 0.5 mass % or more and 5 mass % or less, and may be 1 mass % or more and 3 mass % or less. The non-self-doping conductive polymer contained in the second processing solution has a large particle size, which tends to increase the viscosity of the second processing solution. Therefore, the concentration of the non-self-doping conductive polymer in the second processing solution is preferably lower than that in the processing solution 2a or 2b. The non-self-doping conductive polymer with large particle size is hardly packed into the pores of the porous portion of the anode body, and is likely to form a skin-like film of the non-self-doping conductive polymer outside the porous portion.

### (Cathode Leading Layer)

The cathode leading layer includes at least a first layer contacting the solid electrolyte layer. The cathode leading layer may include a first layer and a second layer covering the first layer. The first layer may be, for example, a layer containing conductive particles, a metal foil, and the like. As the conductive particles, at least one kind of particles selected from a conductive carbon and a metal particle can be used. For example, the cathode leading layer may be constituted of a layer containing a conductive carbon (may be referred to as a carbon layer) as the first layer, and a layer containing metal particles or metal foil, as the second layer. When a metal foil is used as the first layer, the cathode leading layer may be constituted of this metal foil.

Examples of the conductive carbon include graphite, such as artificial graphite and natural graphite. The carbon layer is formed using, for example, a paste or slurry containing a conductive carbon and, as necessary, a binder (binder resin, etc.).

The layer containing metal particles as the second layer can be formed by, for example, laminating a composition containing metal particles (metal powder, etc.) on the surface of the first layer. Such a second layer may be, for example, a metal particle-containing layer (e.g., a metal paste layer, such as silver paste layer) formed using a composition containing metal particles, such as silver particles and a resin (binder resin).

The binder resin used in the carbon layer and the metal particle-containing layer may be a thermoplastic resin, a thermosetting resin, and the like. As the binder resin, a thermosetting resin, such as imide-series resin and an epoxy resin, is preferably used.

When a metal foil is used as the first layer, any kind of metal may be used. For the metal foil, a valve metal, such as aluminum, tantalum, and niobium, or an alloy containing a valve metal is preferably used. The surface of the metal foil may be roughened as necessary. The surface of the metal foil may be provided with a chemical conversion film, and may be provided with a coating of a metal (dissimilar metal) different from the metal constituting the metal foil or of a non-metal. Examples of the dissimilar metal and the non-metal include metals, such as titanium, and non-metals, such as carbon (e.g., conductive carbon).

The aforementioned coating of a dissimilar metal or a non-metal (e.g., conductive carbon) may be used as the first layer, and the aforementioned metal foil may be used as the second layer.

### (Separator)

When a metal foil is used for the cathode leading layer, a separator may be disposed between the metal foil and the anode body (anode foil, etc.). As the separator, without particular limitation, for example, a nonwoven fabric including cellulose, polyethylene terephthalate, vinylon, or polyamide (e.g., aliphatic polyamide, aromatic polyamide such as aramid) fibers may be used.

### (Others)

The solid electrolytic capacitor may be of a wound type, and may be of a chip type or a laminate type. For example, the solid electrolytic capacitor may include two or more capacitor elements laminated together. The solid electrolytic capacitor may include one wound capacitor element, and may include two or more wound capacitor elements. The configuration of the capacitor element may be selected depending on the type of the solid electrolytic capacitor.

In the capacitor element, to the cathode leading layer, one end of a cathode lead terminal is electrically connected, for example. The cathode lead terminal is bonded to the cathode leading layer via a conductive adhesive applied to the cathode leading layer, for example. To the anode body, one end of an anode lead terminal is electrically connected, for example. The other end of the anode lead terminal and the other end of the cathode lead terminal are each drawn out from the resin package body or case. The other end of each terminal exposed from the package body or case is used for solder connection with a substrate on which the solid electrolytic capacitor is to be mounted, or other purposes.

The capacitor element is sealed with a package body (resin package body, etc.) or case. For example, with the capacitor element and the resin material of the package body (e.g., uncured thermosetting resin and filler) placed in a mold, the capacitor element may be sealed in the resin package body by transfer molding, compression molding, or other techniques. At this time, the other end of the anode lead terminal connected to the anode lead and the other end of the cathode lead terminal, which are drawn out from the capacitor element, are each partially exposed from the mold. As the thermosetting resin, for example, an epoxy resin can be used.

Alternatively, the capacitor element may be housed in a bottomed case, such that the other end of the anode lead and the other end of the cathode lead are each partially positioned on the opening side of the bottomed case. By sealing the opening of the bottomed case with a sealing body, a solid electrolytic capacitor can be formed. As the material of the bottomed case, a metal, such as aluminum, stainless steel, copper, iron, and brass, or an alloy of these metals can be used.

FIGURE is a schematic cross-sectional view of a solid electrolytic capacitor according to one embodiment of the present disclosure. A solid electrolytic capacitor 20 includes a capacitor element including an anode part 6 and a cathode part 7, a package body 11 sealing the capacitor element, an anode lead frame 13 electrically connected to the anode part 6, and a cathode lead frame 14 electrically connected to the cathode part 7.

The anode part 6 has an anode body 1 and an anode wire 2. A part of the anode wire 2 is embedded in the anode body 1, and the remainder is extended outward from the outer surface of the anode body 1. A part of the anode lead frame 13 is joined to the extended part of the anode wire 2 by welding or the like, and electrically connected thereto.

A dielectric layer 3 is formed on the surface of the anode body 1. The cathode part 7 includes a solid electrolyte layer 4 covering at least part of the dielectric layer 3, and a cathode leading layer 5 covering at least part of the surface of the solid electrolyte layer 4. The cathode leading layer 5 includes a carbon layer formed so as to cover at least part of the surface of the solid electrolyte layer 4, and a metal particle-containing layer formed so as to cover at least part of the carbon layer. A part of the cathode lead frame 14 is bonded to the cathode leading layer 5 via a conductive adhesive layer 8, and electrically connected thereto.

### EXAMPLES

The present invention will be specifically described below with reference to Examples and Comparative Examples. The present invention, however, is not limited only to the following Examples.

### Example 1

A capacitor element was fabricated in the following procedure, and its characteristics were evaluated.

### (1) Preparation of Anode Body Having Dielectric Layer

A tantalum sintered body (porous body) with an anode wire partially embedded therein was prepared as an anode body. The surface of the tantalum sintered body was anodized, to form a dielectric layer containing tantalum oxide on the surface of the anode body.

### (2) Step of Forming Solid Electrolyte Layer

### (2-1) Step of Forming First Portion

### (Step of Forming First Solid Electrolyte)

An aqueous dispersion (first processing solution) containing a self-doping polythiophene-based polymer was prepared. The concentration of the polythiophene-based polymer in the first processing solution was set to 1 mass % or more and 3 mass % or less. The self-doping polythiophene-based polymer used here was PEDOT (Mw: approx. 10,000) having a sulfo group bonded to the PEDOT backbone via a linking group containing a butylene group.

The tantalum sintered body prepared in the above (1) was immersed in the first processing solution for about 30 to 60 seconds, and then pulled up from the first processing solution. Next, the tantalum sintered body pulled up from the first processing solution was heated (dried) at a temperature of 140 to 180° C. for 10 to 20 minutes, to form a first solid electrolyte.

### (Step of Forming Solid Electrolyte 2a)

An aqueous dispersion (processing solution 2a) containing an antioxidant (pyrogallol), a silane compound (3-glycidoxypropyltriethoxysilane), and a non-self-doping conductive polymer (PSS-doped PEDOT) was prepared. The concentration of the PSS-doped PEDOT in the processing solution 2a was set to 1 mass % or more and 3 mass % or less. The concentration of the pyrogallol in the processing solution 2a was 3 mass %. The concentration of the silane compound in the processing solution 2a was 1 mass %.

The tantalum sintered body with the first solid electrolyte formed therein was immersed in the processing solution 2a for about 30 to 60 seconds, and then pulled up from the processing solution 2a. Next, the tantalum sintered body pulled up from the processing solution 2a was heated (dried) at a temperature of 140 to 180° C. for 10 to 20 minutes. In this way, a tantalum sintered body with a solid electrolyte 2a formed therein was obtained.

### (Step for Forming Solid Electrolyte 2b)

An aqueous dispersion (processing solution 2b) containing an antioxidant (pyrogallol), and a non-self-doping conductive polymer (PSS-doped PEDOT) was prepared. The aqueous dispersion (processing solution 2b) contains no silane compound. The tantalum sintered body with the solid electrolyte 2a formed therein was immersed in the processing solution 2b. Except for these, in the same manner as forming the solid electrolyte 2a, a solid electrolyte 2b was formed. In this way, a second solid electrolyte having the solid electrolytes 2a and 2b was formed.

In the above procedures, a tantalum sintered body in which a first portion having a first solid electrolyte and a second solid electrolyte was formed was prepared.

### (2-2) Step for Forming Second Portion

An aqueous dispersion (second processing solution) containing a non-self-doping conductive polymer (PSS-doped PEDOT) was prepared. The concentration of the PSS-doped PEDOT in the second processing solution was set to 1 mass % or more and 3 mass % or less. The tantalum sintered body with the first portion formed therein was immersed in the second processing solution for about 30 to 60 seconds, and then, the tantalum sintered body was pulled up from the second processing solution. Next, the tantalum sintered body pulled up from the second processing solution was heated (dried) at a temperature of 140 to 180° C. for 10 to 20 minutes. The immersion of the tantalum sintered body in the second processing solution and the above drying were repeated a plurality of times, to form a second portion of the solid electrolyte layer.

### (3) Formation of Cathode Leading Layer

The tantalum sintered body obtained in the above (2) with the solid electrolyte layer formed therein was immersed in a dispersion of graphite particles in water, and then pulled out from the dispersion, and dried, to form a carbon layer (first layer) on the surface of the solid electrolyte layer. The drying was performed at 180° C. for a duration of 10 to 30 minutes.

Next, a silver paste containing silver particles and a binder resin (epoxy resin) was applied onto a surface of the carbon layer, followed by drying at a temperature of 60 to 80° C. for 20 to 40 minutes. This was followed by further heating at 180° C. for 30 to 60 minutes, to cure the binder resin, into a metal particle-containing layer (second layer). In this way, a cathode leading layer constituted of a carbon layer and a metal particle-containing layer was formed.

In the above procedures, a total of 60 capacitor elements E1 were fabricated, each including a cathode part constituted of the solid electrolyte layer and the cathode leading layer.

### Comparative Example 1

The whole second solid electrolyte was formed using an aqueous dispersion containing a non-self-doping conductive polymer (PSS-doped PEDOT). This aqueous dispersion contains neither an antioxidant nor a silane compound. Except for these, in the same manner as fabricating the capacitor elements E1, a total of 60 capacitor elements C1 were fabricated.

### Reference Example 1

The whole second solid electrolyte was formed using only the processing solution 2b. Except for this, in the same manner as fabricating the capacitor elements E1, a total of 60 capacitor elements R1 were fabricated.

### Comparative Example 2

A solid electrolyte 2a was formed in the same manner as in Example 1, except that a processing solution 2a containing no antioxidant was used. A solid electrolyte 2b was formed in the same manner as in Example 1, except that the processing solution 2b containing no antioxidant was used. Except for these, in the same manner in as Example 1, a total of 60 capacitor elements C2 were fabricated.

The capacitor elements E1 contain an antioxidant in the second solid electrolyte in the first portion of the solid electrolyte layer, and a resistive component (silane compound) in the solid electrolyte 2a.

The capacitor elements C1 contain neither an antioxidant nor a resistive component (silane compound) in the first portion of the solid electrolyte layer.

The capacitor elements R1 contain an antioxidant in the second solid electrolyte in the first portion of the solid electrolyte layer. The first portion contains no resistive component (silane compound).

The capacitor elements C2 contain a resistive component (silane compound) in the solid electrolyte 2a in the first portion of the solid electrolyte layer. The first portion contains no antioxidant.

### [Evaluation]

The following evaluations were performed with respect to the capacitor elements of Example, Comparative Examples, and Reference Example, or a thin film formed using the processing solution 2a or 2b.

### (1) Reliability Test

In a 20° C. environment, an initial capacitance (μF) at a frequency of 120 Hz of the capacitor elements was measured using a four-terminal LCR meter. An average value C0 (μF) for 60 capacitor elements was then calculated.

With respect to 20 capacitor elements, at 25° C., an ON-OFF test in which each capacitor element was charged to the rated voltage and discharged to 0 V was repeated 10,000 cycles in total. Then, a capacitance C1 (μF) was measured in the same manner as above, and an average value C1 (μF) was calculated. A capacitance decrease rate (%) of the capacitance C1 relative to the initial capacitance C0 was calculated from the following formula.

Capacitance decrease rate (%)=(C1−C0)/C0×100

### (2) Leakage Current (LC) Failure Rate

With respect to 20 capacitor elements not subjected to the ON-OFF test, a 1-kΩ resistor was connected in series, and a voltage of 30 to 60 V was applied with a DC power supply. The leakage current value (unit: A) was measured 40 seconds after the start of voltage application. For the measurement of the leakage current, Semiconductor Parameter Analyzer 4155B manufactured by Agilent Technologies, Inc. was used. The number of the capacitor elements in which the leakage current value was 100 A or more in the 20 capacitor elements was determined as a percentage (%), which was taken an LC failure rate.

### (3) Withstand Voltage Performance

With respect to 20 capacitor elements not subjected to the ON-OFF test, a voltage was applied at a voltage increase rate of 1.0 V/sec, to measure a breakdown voltage (BVD) (unit: V) at which an overcurrent of 0.5 A flowed. The withstand voltage performance was expressed as a relative value, with the BVD (V) of the solid electrolytic capacitor of Comparative Example 1 taken as 1.00. The higher the value is, the higher the withstand voltage performance is.

### (4) Silicon Element Content by Mass in Solid Electrolytes 2a and 2b

With respect to Example 1 and Comparative Example 2, the silicon element content by mass in each solid electrolyte was determined in the already-described procedures.

### (5) Conductivity of Solid Electrolytes 2a and 2b

A thin film 2a (thickness 5 μm) of the solid electrolyte 2a was formed using the processing solution 2a of Example 1 in the already-described procedures. A thin film 2b (thickness 5 μm) of the solid electrolyte 2b was formed in the same manner as above, except that the processing solution 2b of Example 1 was used instead of the processing solution 2a. The conductivity (S/cm) of each of the thin films 2a and 2b was measured in the already-described procedures. The result found that the conductivity of the thin film 2a was 1 S/cm or less, and the conductivity of the thin film 2b was 200 S/cm or more.

The evaluation results are shown in Table 1.

TABLE 1

| | | | | LC | withstand | capacitance |
|---|---|---|---|---|---|---|
| | antioxidant | | | failure | voltage | decrease |
| capacitor | in first | | | rate | performance | rate |
| No. | portion | conductivity | Si content | [%] | (STD value) | [%] |
| C1 | without | — | | 4.2 | 1.00 | −30.20 |
| R1 | with | — | | 15.0 | 1.01 | −5.03 |
| C2 | without | C2a < C2b | solid electrolyte 2a > | 4.0 | 1.05 | −32.80 |
| | | | solid electrolyte 2b | | | |
| E1 | with | C2a < C2b | solid electrolyte 2a > | 5.1 | 1.06 | −6.21 |
| | | | solid electrolyte 2b | | | |

Table 1 shows that when the second solid electrolyte in the first portion contains a non-self-doping conductive polymer and an antioxidant component, the decrease in capacitance rate during repeated charging and discharging can be significantly reduced as compared to when the second solid electrolyte contains no antioxidant component (comparison between C1 and R1). In R1, however, the LC failure rate increased significantly. By configuring the second solid electrolyte with the solid electrolytes 2a and 2b, whose conductivities satisfied the relationship C2a<C2b, the LC failure rate was significantly reduced (comparison between R1 and E1).

Even when the second solid electrolyte in the first portion was configured with the solid electrolytes 2a and 2b, whose conductivities satisfied the relationship C2a<C2b, the decrease in capacitance rate after repeated charging and discharging was large when the first portion did not contain the antioxidant component (C2). In contrast, in E1, in which the first portion contained the antioxidant component, in addition to having the configuration of C2, the decrease in capacitance rate was significantly reduced (comparison between C2 and E1). A comparison of C1 with R1 shows when the first portion contains the antioxidant component, the LC failure rate significantly increases. However, a comparison of C2 and E1 shows that when the second solid electrolyte contains the solid electrolyte 2a and 2b, the influence of the antioxidant component on the LC failure rate is reduced.

Furthermore, by configuring the second solid electrolyte in the first portion with the solid electrolyte 2a and 2b, whose conductivities satisfied the relationship C2a<C2b, high withstand voltage performance was achieved (comparison of C1 and R1 with C2 and E1).

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

In the solid electrolytic capacitor according to the present disclosure, the decrease in capacitance after repeated charging and discharging can be suppressed. In addition, in the solid electrolytic capacitor, the leakage current is reduced. Therefore, the solid electrolytic capacitor according to the present disclosure is suitable for applications requiring high reliability and long life. The applications of the solid electrolytic capacitor are not limited to them only.

### REFERENCE NUMERALS

20: solid electrolytic capacitor
   1: anode body
   2: anode wire
   3: dielectric layer
   4: solid electrolyte layer
   5: cathode leading layer
   6: anode part
   7: cathode part
   8: conductive adhesive layer
11: package body
13: anode lead frame
14: cathode lead frame

What is claimed is:

1. A solid electrolytic capacitor, comprising:
at least one capacitor element; and a package body, wherein
the capacitor element includes an anode body including a porous portion at least in a surface layer, a dielectric layer covering at least part of a surface of the anode body, and a solid electrolyte layer covering at least part of the dielectric layer,
the solid electrolyte layer has a first portion packed in voids of the porous portion in the anode body having the dielectric layer, and a second portion protruding from a principal surface of the anode body having the dielectric layer,
the first portion contains an antioxidant component, and includes a solid electrolyte 2a, and a solid electrolyte 2b covering at least part of the solid electrolyte 2a,
the solid electrolyte 2a includes a non-self-doping conductive polymer 2a,
the solid electrolyte 2b includes a non-self-doping conductive polymer 2b, and
a conductivity C2a measured with respect to the solid electrolyte 2a and a conductivity C2b measured with respect to the solid electrolyte 2b satisfies C2a<C2b.

2. The solid electrolytic capacitor according to claim 1, wherein
the first portion includes a first solid electrolyte covering at least part of the dielectric layer, and a second solid electrolyte covering at least part of the first solid electrolyte,
the first solid electrolyte includes a self-doping conductive polymer, and
the second solid electrolyte includes the solid electrolyte 2a covering at least part of the first solid electrolyte, and the solid electrolyte 2b.

3. The solid electrolytic capacitor according to claim 1, wherein the conductivity C2b measured with respect to a thin film having a thickness of 5 μm of the solid electrolyte 2b is 200 S/cm or more.

4. The solid electrolytic capacitor according to claim 1, wherein the conductivity C2a measured with respect to a thin film having a thickness of 5 μm of the solid electrolyte 2a is 1 S/cm or less.

5. The solid electrolytic capacitor according to claim 1, wherein a ratio T2b/T2a of an average thickness T2b of the solid electrolyte 2b to an average thickness T2a of the solid electrolyte 2a is 2 or more and 5 or less.

6. The solid electrolytic capacitor according to claim 1, wherein
the second portion contains no antioxidant component or contains an antioxidant component, and
a content ratio by mass of the antioxidant component in the first portion is higher than a content ratio by mass of the antioxidant component in the second portion.

7. The solid electrolytic capacitor according to claim 1, wherein the second portion does not contain the antioxidant component.

8. The solid electrolytic capacitor according to claim 1, wherein the first portion contains silicon element.

9. The solid electrolytic capacitor according to claim 8, wherein a silicon element content by mass in the solid electrolyte 2a is higher than a silicon element content by mass in the solid electrolyte 2b.

10. A method for producing a solid electrolytic capacitor including at least one capacitor element and a package body,
the capacitor element including: an anode body including a porous portion at least in a surface layer of the anode body; a dielectric layer covering at least part of a surface of the anode body; and a solid electrolyte layer covering at least part of the dielectric layer, wherein
the solid electrolyte layer has a first portion packed in voids of the porous portion in the anode body having the dielectric layer, and a second portion protruding from a principal surface of the anode body having the dielectric layer,
the method comprising a step of forming the solid electrolyte layer, wherein
the step of forming the solid electrolyte layer includes a step of forming the first portion, and a step of forming the second portion,
the step of forming the first portion includes a step of forming a solid electrolyte 2a using a processing solution 2a containing a non-self-doping conductive polymer 2a, and a step of forming a solid electrolyte 2b using a processing solution 2b containing a non-self-doping conductive polymer 2b so as to cover at least part of the solid electrolyte 2a,
at least one of the processing solution 2a and the processing solution 2b further contains an antioxidant component,
the processing solution 2a further contains a resistive component,
the processing solution 2b contains no resistive component or further contains a resistive component, and
a concentration of the resistive component in the processing solution 2a is higher than a concentration of the resistive component in the processing solution 2b.

11. The method for producing a solid electrolytic capacitor according to claim 10, wherein the resistive component includes a silane compound.

12. The solid electrolytic capacitor according to claim 10, wherein
the first portion includes a first solid electrolyte covering at least part of the dielectric layer, and a second solid electrolyte covering at least part of the first solid electrolyte,
the second solid electrolyte includes the solid electrolyte 2a covering at least part of the first solid electrolyte, and the solid electrolyte 2b,
the step of forming the first portion includes a step of forming the first solid electrolyte using a first processing solution containing a self-doping conductive polymer, and
the step of forming the solid electrolyte 2a is performed so as to cover at least part of the first solid electrolyte.
